(19) United States
(12) Patent Application Publication
(10) Pub. No.: US 2024/0416668 A1
(43) Pub. Date: Dec. 19, 2024

(54) CLEANING ACCESSORIES

(71) Applicant: Hewlett-Packard Development Company, L.P., Spring, TX (US)

(72) Inventors: Eduardo AMELA CONESA, Sant Cugat del Valles (ES); Alexander Jose PEREZ GARCIA, Sant Cugat del Valles (ES); Maurizio BORDONE, Sant Cugat del Valles (ES)

(73) Assignee: Hewlett-Packard Development Company, L.P., Spring, TX (US)

(21) Appl. No.: 18/705,123

(22) PCT Filed: Oct. 27, 2021
(86) PCT No.: PCT/US2021/056903

§ 371 Date: Apr. 26, 2024

(51) Int. Cl. B41J 29/17; B08B 5/04

(52) U.S. Cl. CPC B41J 29/17; B08B 5/04

(57) ABSTRACT

A printing apparatus is disclosed herein. The apparatus comprises a platen and a carriage. The platen has a printing zone, the platen being to hold a media moveable along a media path direction. The carriage includes a cleaning accessory interface couplable to a cleaning accessory, the cleaning accessory to remove contaminants from the platen upon the carriage's movement; and a conduit connectable to a vacuum source to extract the removed contaminants from the printing zone.

### BACKGROUND

Printers are devices that record images on a printing media. Printers comprise printheads in a carriage that selectively propel an amount of printing fluid on the media. Some printers may include internal printing fluid reservoirs. Other printers may use external printing fluid cartridges as printing fluid reservoirs.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1A is a schematic diagram showing an example of a front view of a printing apparatus with a media thereon during a printing operation;

FIG. 1B is a schematic diagram showing an example of a from view of the printing apparatus of FIG. 1A during a servicing operation;

FIG. 2 is a flowchart of an example method for removing contaminants from a platen of a printing apparatus;

FIG. 3 is a flowchart of another example method for removing contaminants from a platen of a printing apparatus;

FIG. 4 is a flowchart of an example method for determining whether a servicing operation is to be executed; and

FIG. 5 is a block diagram showing a processor-based system example to remove contaminants from a platen of a printing apparatus.

### DETAILED DESCRIPTION

The following description is directed to various examples of printing systems. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As used herein, the terms “about” and “substantially” are used to provide flexibility to a range endpoint by providing that a given value may be, for example, an additional 15% more or an additional 15% less than the endpoints of the range. In another example, the range endpoint may be an additional 30% more or an additional 30% less than the endpoints of the range. The degree of flexibility of this term can be dictated by the particular variable and would be within the knowledge of those skilled in the art to determine based on experience and the associated description herein.

For simplicity, it is to be understood that in the present disclosure, elements with the same reference numerals in different figures may be structurally the same and may perform the same or a similar functionality.

Printing apparatuses, such as printers, comprise a carriage having elements to selectively propel an amount of printing fluid on a media. In some printers, the carriage is a fixed carriage spanning at least the full width of the printable area of the media, such that as the media travels underneath, some elements from the carriage propel the printing fluid and thereby generate the image to be recorded on the media. In other examples, however, the carriage is a scanning carriage which does not span the full width of the printable area of the media. The scanning carriage is therefore controllable to scan across substantially the full width of the printable area of the media (i.e., scanning direction) and to selectively propel the printing fluid on the media. These apparatuses are commonly referred to as scanning printers.

Printers additionally comprise a printing platform or platen located under the printing carriage such that the media travels between the platen and the carriage during a printing operation. In some examples, the media may travel at a constant speed (e.g., continuous printing). In other examples, such as in scanning printers, the media may travel in discretional advance segments.

The quality of printed products may be affected by the environment in which the printer is operating. Dirty environments tend to affect the quality of the printed products. Some environments may comprise cloth fibers (e.g., wool, cotton), hairs and/or similar airborne elements. On top of that, some printers operate in the same room as other machinery equipment, for example cardboard cutting machines, which may generate further airborne elements, such as cellulose fibrous elements.

These airborne elements may clog nozzles of the printer and/or may deposit on the platen thereby generating part quality artifacts. Some part quality defects occasioned due to these airborne particles may include cracking or flaking. Additionally, some printing fluid remnants may traverse through the media and reach the platen and remain (e.g., stuck) thereon. These printing fluid remnants may also generate part quality defects in the generated printed product and may affect to the well-use of the printer. As such, providing with a printing apparatus with an integrated cleaning mechanism would enhance the quality of the generated printed products as well as extend the lifespan of the printing apparatus.

In the examples herein, the terms “width” and “length” have been used. The two terms are intended to denote two substantially orthogonal directions within a horizontal plane. In further examples, the terms width and length may be used interchangeably. Furthermore, the terms “laterally” and “vertically” have been used. These terms are intended to further denote two substantially orthogonal directions, where laterally is a direction within the horizontal plane and vertically is the orthogonal direction from the horizontal plane (e.g., normal vector). In some examples herein, the “vertical” direction is further referred to media path direction, and the “horizontal” directions is further referred to as scanning direction.

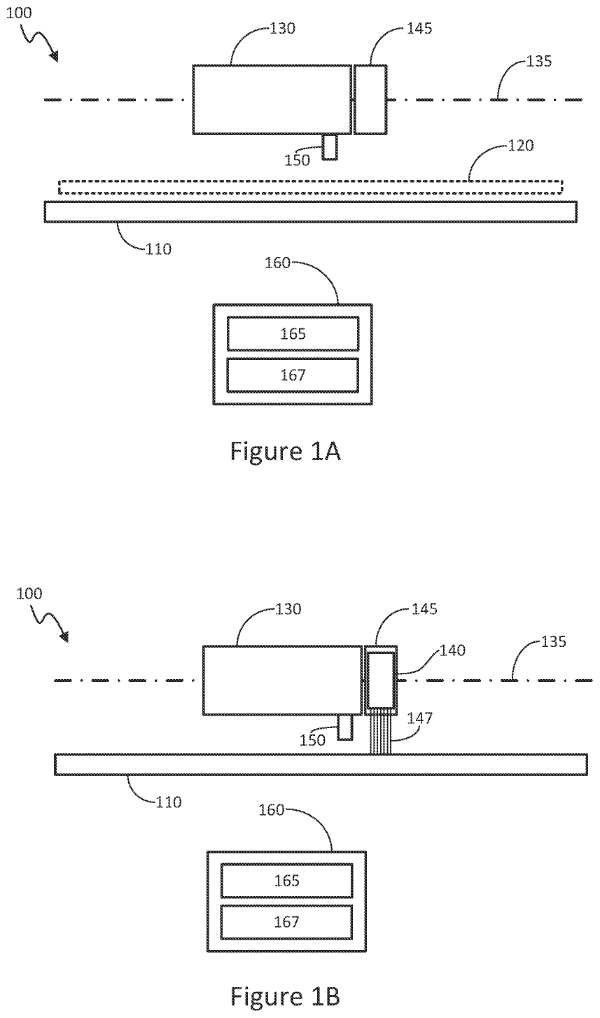

Referring now to the drawings, FIG. 1A-1B are schematic diagrams showing examples of a front view of a printing apparatus 100, such as a printer, during a printing operation (i.e., FIG. 1A) and a servicing operation (i.e., FIG. 1B) respectively. A printing operation may be understood as the operation in which the printer ejects printing fluid to generate the printed product. A servicing operation may be understood as maintenance operations (e.g., cleaning) scheduled when the printer is not in the printing operation.

The printing apparatus 100 comprises a platen 110 defining a printing zone. The printing zone is the printable area on the platen 110 which is reachable by a carriage 130 to record an image to a media 120 located thereon. The platen 110 is to hold a media 120 thereon. The media 120 is to move along the length of the platen 110, for example, along a media path direction. In the examples herein, the media 120 has been illustrated in dotted lines for clarity purposes, as it is an external element from the apparatus 100 that interacts with the apparatus 100 (e.g., the media 120 may not be present during transportation of the apparatus 100). In some examples, such as the example depicted in FIG. 1A, the width of the media 120 covers substantially the full printable area on the platen 110. In other examples (not shown) however, the width of the media 120 covers a portion of the printable area on the platen 110. In yet other examples, the platen 110 is to hold a plurality of medias 120, the width of the combined plurality of medias 120 covering, at most, substantially the entire printable area on the platen 110.

In some examples, the platen 110 may be a porous platen fluidically connectable to a vacuum source (not shown) such that, when in use, the vacuum source is controlled to cause vacuum conditions to the at least the print area of the platen 110. In some examples, the porous platen may be implemented as a solid platen 110 made out of a porous material with air pockets to enable air to traverse therethrough. In other examples, however, the platen 110 may include a set of perforations or pores of a predefined size or set of predefined sizes distributed across the surface of the platen 110 in fluid communication with the vacuum source. The pores or perforations are to enable a fluid, such as air, to traverse therethrough. The vacuum conditions provide a suction force to the media 120 such that substantially the entire lower surface of the media 120 sticks to the upper surface of the platen 110, thereby substantially inhibiting a vertical movement of the media 110 while enabling a movement of the media along the media path direction.

In some specific examples, the printing apparatus 100 may be part of a production line including additional modules to generate a printed object. In these examples, the platen 110 may be implemented as a conveyor belt or transfer belt to move the media 120 from the apparatus 100 to a subsequent production line station. In other examples, however, the printer may be a standalone printer and the platen 110 may also be implemented as a conveyor belt or transfer belt to, for example, move rigid and/or heavy media along the printing zone of the printing apparatus 100. In any case, in the examples herein, a conveyor belt o transfer belt be understood as a surface to hold the media thereon, the surface being moveable relative to the printing apparatus 100. In some examples, the conveyor or transfer belt comprises chained interlocks in which agent remnants and debris (e.g., airborne contaminants) may accumulate therein.

In some examples, the apparatus 100 comprises a carriage 130 including a set of printheads (not shown) in fluid communication with a set of printing fluids from a supply or cartridge. Some examples of printheads may include thermal inkjet printheads, piezoelectrical printheads, or any other suitable type of printhead. In some examples, the printheads are removable printheads. In other examples, the printheads are an integral part of the carriage. The supply may be an external element from the apparatus 100. In some examples, the supply is to be hosted in the carriage 130, for example in a designated slot within the carriage 130. In other examples, the supply is to be hosted away from the carriage 130 with fluid pathways that fluidically connect the supply with the carriage 130 and/or the printheads within the carriage 130.

The carriage 130 may be controllable to reciprocate laterally along a scanning direction 135 (i.e., substantially orthogonal to the media path direction) and over the platen 110. When in use, the carriage 130 is further controllable such that the printheads selectively eject amount of a set of printing fluids on the media 120 based on previously received print job data. The print job data may be a digital product including the images and/or text to be recorded on the media. The print job data may be received in a plurality of digital formats, such as JPEG, TIFF, PNG, PDF and the like.

In some examples, the printheads may eject a plurality of printing fluids. A printing fluid may be a solution of pigments dispersed in a liquid carrier such as water or oil. Some recording printing fluids may include Black ink, White ink, Cyan ink, Yellow ink, Magenta ink, Red ink, Green ink, and/or Blue ink. Other non-recording printing fluids may be used to provide additional properties to the printing fluids ejected on the media 120, for example, resistance to light, heat, scratches, and the like.

The carriage 130 further includes a cleaning accessory interface 145 to receive a cleaning accessory 140 (not shown in FIG. 1A). The cleaning accessory 140 is described further below with reference to FIG. 1B. The cleaning accessory interface 145 may include locking elements to enable a convenient attachment and detachment of the cleaning accessory 140. In some examples, the cleaning accessory 140 is not installed (i.e., attached to the cleaning accessory interface 145) during the printing operation but it is installed during the servicing operation. In some examples, the cleaning accessory 140 is manually attached and detached from the cleaning accessory interface 145. In other examples, the cleaning accessory 140 is automatically attached/detached from the interface 145 through, for example, robotic means.

In FIG. 1B, the cleaning accessory 140 is attached to the cleaning accessory interface 145. The cleaning accessory 140 is to remove contaminants from the platen 110 upon the movement of the carriage 130. In the examples herein, the term contaminants may be referred to debris, printing agent remnants on the platen, and the like.

In some examples, the cleaning accessory 140 may include a body with a cleaning portion. The cleaning portion may be implemented as a set of bristles 147 or brush-like elements. The bristles 147 should be made of a material which is hard enough to remove the contaminants from the platen 110 and soft enough such that the bristles 147 do not damage the platen 110. In some examples, the bristles are made of a material such as Nylon (e.g., Nylon 6, 6.6 or 6.12), polypropylene, horsehair, TAMPICO, steel or Brass. Table 1 show suitable material examples of the bristles 147 including its bend recovery in %, its abrasion resistance, its density (g/cm3), tensile strength (MPa) and Hardness (Rockwell) values.

TABLE 1

| | Nylon | | | | | | | |
|---|---|---|---|---|---|---|---|---|
| | 6 | 6.6 | 6.12 | POLYPRO- | HORSE | | | |
| | NYLON | NYLON | NYLON | PYLENE | HAIR | TAMPICO | Steel | Brass |
| Bend | 90 | 90 | 90 | 70-80 | excel. | poor | | |
| Recovery | | | | | | | | |
| (%) | | | | | | | | |
| Abrasion | good | excel. | excel. | good | good | poor | excel. | excel. |
| Resistance | | | | | | | | |
| Density | 1.13-4 | 1.13-4 | 1.04-5 | 0.90-1 | 1.3 | 0.6 | 7.9 | 8.5 |
| (gr/cm3) | | | | | | | | |
| Tensile | 45-90 | 45-90 | 45-90 | 36 | — | — | 350 | 250 |
| Strength | | | | | | | | |
| (MPa) | | | | | | | | |
| Hardness | 70-125 | 70-125 | 70-125 | 58-79 | — | — | 71-112 | 54-100 |
| (Rockwell) | | | | | | | | |

The bristles 147 should be long enough such that when in the cleaning accessory 140 is attached to the cleaning accessory interface 145, the bristles 147 reach the platen 110. As such, the length of the bristles 147 may be based on the distance between the carriage 130 and the platen 110. In some examples, the bristles 147 length may range from about 10 mm to about 20 mm, for example about 15 mm.

In some examples, before the servicing operation, the cleaning portion of the cleaning accessory 140 (e.g., the bristles 147) may be wet with a solvent to enhance the removal of printing fluid and other contaminants stuck on the platen 110. Some examples of suitable solvents may include isopropyl alcohol or any other suitable solvent.

Once the cleaning accessory 140 is attached to the cleaning accessory interface 145, a controller 160 is to control the carriage 130 to reciprocate across and above the width of the platen 110. Enabled by the movement of the carriage, the cleaning portion of the cleaning accessory is to scrape printing fluid remnants, to release trapped particles in the conveyor or transfer belt interlocking chain gaps and raise dust and other particles to be extracted by a conduit 150.

In further examples in which the platen 110 is a moveable platen along the media path direction (e.g., conveyor or transfer belt), the movement of the platen 110 along the media path direction and the movement of the carriage 130 along the scanning direction 135 are synchronized such that the cleaning accessory 140 cleans the platen 110 as the platen 110 moves along the media path direction. In some examples, the movement of the carriage 130 and the platen 110 are synchronized such that substantially every addressable portion of the platen 110 is cleaned by the cleaning accessory 140.

The carriage 130 further includes a conduit 150. The conduit 150 may be any structure suitable for transporting a fluid such as gas (e.g., air) or liquid (e.g., ink aerosol). In some examples, the conduit 150 may comprise a pipe, a hose, or a duct. In some examples, the conduit 150 is an aerosol extractor. The conduit 150 is connectable to a vacuum source (not shown). A vacuum source may be any device suitable for generating an airflow from the printing zone through the conduit 150. Examples of vacuum source may comprise pumps, fans, and the like.

In some examples, the conduit 150 may be placed at a bottom section of the carriage 130 or at a lateral wall of the carriage 130. In any case, in some examples, the nozzle (i.e., outlet) of the conduit 150 is to face the platen 110. In some examples, the nozzle of the conduit 150 is located at a distance of about 5 mm or less from the platen 110, for example, about 5 mm, 1 mm, 0.5 mm or 0.1 mm. In some examples, the conduit 150 includes a vertically moving mechanism to move the conduit 150 vertically. In these examples, the vertically moving mechanism is controlled to move the nozzle of the conduit 150 to a distance from the platen 110 which is based on the media 120 used during the printing operation, the type of printer (i.e., printing apparatus 100), the vacuum source and/or the printing apparatus 100 settings.

In some examples, the conduit 150 is present in both printing and servicing operations. In other examples, however, the conduit 150 is attachable and detachable from the container 130 in, for example, a similar manner as the cleaning accessory 140 with respect to the cleaning accessory interface 145.

The conduit 150, when in use during the servicing operation, is to direct the airflow to extract any removed contaminants from the print zone through the conduit 150. In some examples, the removed contaminants are the contaminants extracted by the cleaning accessory 140 during the servicing operation as the carriage 130 is controlled to scan over the platen 110. The contaminants extracted by the conduit 150 are directed to the opposite end of the conduit 150 where they may be stored and discarded.

In an example, a vacuum source fluidically connected to the conduit 150 is controlled to generate the airflow in the conduit 150 to have an average speed from about 0.01 m/s to about 1 m/s, for example about 0.7 m/s. In another example, the vacuum source is controlled to generate a gas flow in the conduit 150 to have an average speed from about 0.1 m/s to about 0.5 m/s, for example about 0.25 m/s. In yet another example, the vacuum source is controlled to generate a gas flow in the conduit 150 to have an average speed from about 0.2 m/s to about 0.4 m/s, for example about 0.38 m/s.

In some examples, the carriage 130 further comprises an additional conduit (not shown) to further extract the removed contaminants from the printing zone. In some examples, the conduit 150 and the additional conduit are located at opposite sides of the carriage 150 with respect to the scanning direction 135. In other examples, the conduit 150 and the additional conduit are located next to each other.

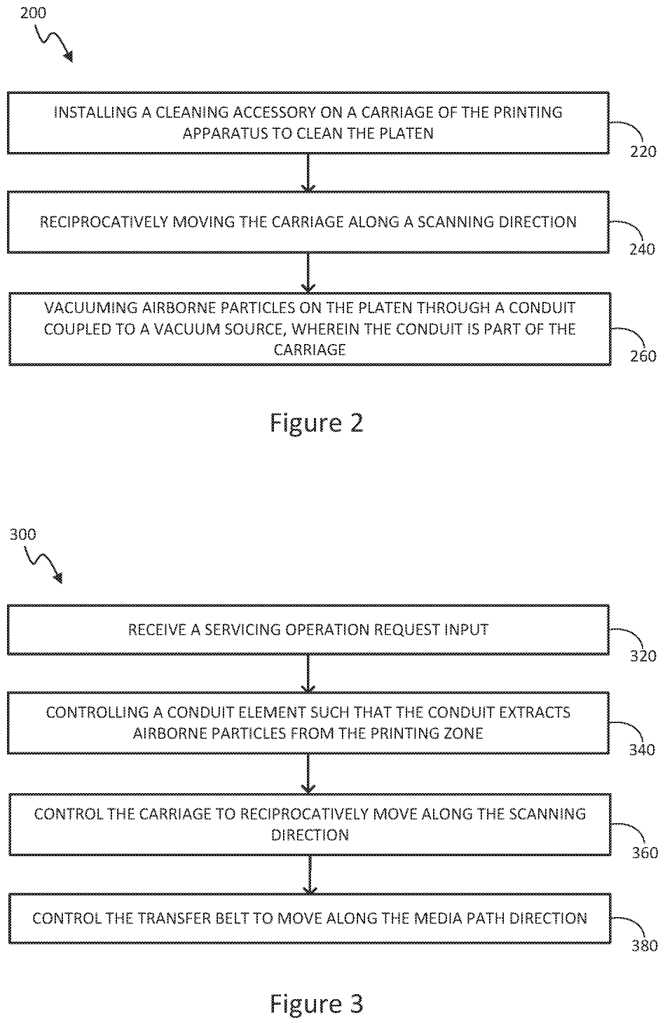

The printing apparatus 100 comprises a controller 160. The controller 160 comprises a processor 165 and a memory 167 with specific control instructions to be executed by the processor 165. The functionality of the controller 160 is described further below with reference to FIGS. 2, 3 and 4.

In the examples herein, the controller 160 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 160 may be, at least partially, implemented in the form of an electronic circuitry. The controller 160 may be a distributed controller, a plurality of controllers, and the like. In the examples herein, the carriage 130 and the conduit 150 are coupled to the controller 180 to execute the functionalities described herein. Additionally, in some examples herein, the platen 110 (e.g., conveyor or transfer belt) is further coupled to the controller 180 to execute the functionalities described herein.

FIG. 2 is a flowchart of an example method 200 for removing contaminants from a platen 110 of a printing apparatus 100. In some examples, method 200 may be executed, at least in part, by the controller 160 of the printing apparatus 100. The method 200 may involve previously disclosed elements from FIG. 1 referred to with the same reference numerals.

Method 200 may start when a servicing request, for example a cleaning request, is received (see, e.g., block 320 of FIG. 3).

At block 220, the controller 160 is to control a robot or a controllable mechanical device to install the cleaning accessory 140 on the carriage 130 of the printing apparatus 100. In other examples, a user or technician is to manually attach (i.e., install) the cleaning accessory 140 to the cleaning accessory interface 145 of the carriage 130.

Once the cleaning accessory 140 is installed on the carriage, at block 240, the controller 160 controls the carriage 160 to reciprocate along the scanning direction 135. As the cleaning accessory 140 is attached to the carriage 130, the movement of the carriage 130 enables the cleaning portion (e.g., bristles 147) to clean the platen 110. As such, the movement of the carriage 130 enables the cleaning accessory 140 to scrape printing fluid remnants, to release trapped particles within a conveyor or transfer belt interlocking chain gaps and raise dust and other particles to be extracted by a conduit 150.

At block 260, the controller 160 is to control a vacuum source fluidically coupled to the conduit 150 to vacuum airborne particles on the platen 110 through the conduit 150. In some examples, the airborne particles are vacuumed and removed from the printing zone as the carriage 130 reciprocates along the scanning direction 135. In examples, the airborne particles removed through the conduit 150 are, at least in part, contaminant particles from the platen 110 which became airborne due to the cleaning operation executed by the cleaning accessory 140. In some examples, the cleaning accessory interface 145 and the conduit 150 nozzle are located next to each other to remove the cleaned (i.e., raised) contaminant particles by the cleaning accessory 140 and thereby inhibit the contamination of other parts of the printing apparatus 100 hardware, for example, clogging printhead nozzles.

FIG. 3 is a flowchart of another example method 300 for removing contaminants from a platen 110 of a printing apparatus 100. In some examples, method 300 may be executed, at least in part, by the controller 160 of the printing apparatus 100. The method 300 may involve previously disclosed elements from FIG. 1 referred to with the same reference numerals.

At block 320, the controller 160 or the user/technician is to receive a servicing operation request input. In some examples, the servicing operation request input is manually introduced by the user who, by visual inspection or other means, is to detect that a cleaning operation is needed. In other examples in which the platen 110 is a conveyor or transfer belt, the servicing operation request input may be generated after a predetermined number of belt turns. The predetermined number of belt turns may be a default value or manually introduced by the user or technician.

In other examples, the servicing operation request input may be automatically generated, for example by the controller 160, as being a part of a servicing routine. The servicing routine may have different setting modes, for example a servicing routine for dirty environments and a servicing routing for clean environments. To set an example, the servicing routine for dirty environments may be triggered from every about 1 month to about 3 months, for example every about 2 months; and the servicing routine for clean environments may be triggered from every about 5 months to about 7 months, for example every about 6 months. The user may program the controller 160 with a setting value including whether the working environment of the printing apparatus 100 is a clean or a dirty environment.

In some examples, after block 320, the controller 160 is to determine that the cleaning accessory 140 is correctly installed in the printing apparatus 100. In some examples, the cleaning accessory interface 145 is to include a sensor connectable to the controller 160 (e.g., pressure sensor) to detect the correct attachment of the cleaning accessory 140 in the interface 145. In other examples, the user or technician is to manually input to, for example, a user interface connectable to the controller 160 (e.g., touch screen) that the cleaning accessory 140 is correctly installed in the interface 145.

At block 340, the controller 160 controls the conduit element 150 such that the conduit extract airborne particles (e.g., contaminants) from the printing zone. Block 340 may be the same as or similar to block 260 of method 200 (see, e.g., FIG. 2).

At block 360, the controller 160 is to control the carriage 130 to reciprocatively move along the scanning direction 135. Block 360 may be the same as or similar to block 240 of method 200 (see, e.g., FIG. 2).

In the examples in which the platen 110 is a conveyor or transfer belt, at block 380, the controller 160 is to control the conveyor or transfer belt to move along the media path direction as the carriage 130 reciprocatively moves along the scanning direction 135. That way, synchronizing the movement of the belt along the media path direction and the movement of the carriage 130 along the scanning direction 135 enables the cleaning accessory 140 to clean different portions of the belt as the belt moves along the media path direction. In some examples, the movement of the carriage 130 and the belt is synchronized such that substantially every addressable portion of the belt is cleaned by the cleaning accessory 140.

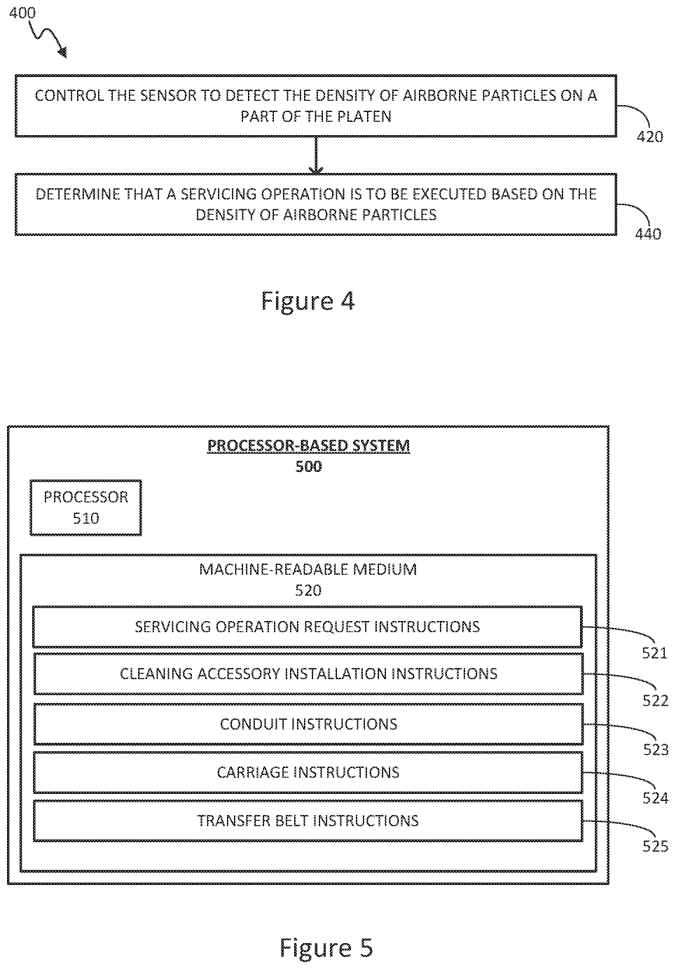

FIG. 4 is a flowchart of an example method 400 for determining whether a servicing operation is to be executed or not. In some examples, method 400 may be executed by the controller 160 of the printing apparatus 100. The method 400 may involve previously disclosed elements from FIG. 1 referred to with the same reference numerals. In some examples, method 400 may be executed instead of block 320 of FIG. 3.

In some examples, the printing apparatus 100 may further include a sensor mounted on the carriage 130 to detect airborne particles on a part of a platen 110. In some examples, the sensor may be a LED, an emitter/receiver optical sensor, piezoelectric debris sensor and/or a vision-based dirt detector. The controller 160 may be couplable to the sensor.

At block 420, the controller 160 is to control the sensor to detect the density of airborne particles on a part of the platen 110. In additional examples, the sensor further detects the presence of contaminants (e.g., printing fluid, trapped particles in interlocking chain gaps) on part of the platen 110 or transfer belt. In some examples, the term “density” should be understood as the area of the platen 110 covered by the airborne particles. It is also noted that additional parameters may be used to measure the number of particles and the size of particles in a given surface value of platen 110 (e.g., 1 square inch).

At block 440, the controller 160 is to determine that a servicing operation is to be executed based on the density of airborne particles. In some examples, the detected density of particles is compared to a predetermined threshold value. The threshold value might be determined empirically. In any case, the controller 160 may determine that a servicing operation is to be executed if the detected density of particles exceeds the predetermined threshold value.

FIG. 5 is a block diagram showing a processor-based system 500 example to remove printing contaminants from a platen of a printing apparatus, for example platen 110 of printing apparatus 100. In the examples herein, the instructions of system 500 may involve previously disclosed elements from FIGS. 1A-1B, 2-4 referred to with the same reference numerals.

In some implementations, the system 500 is a processor-based system and may include a processor 510 coupled to a machine-readable medium 520. The processor 510 may include a single-core processor, a multi-core processor, an application-specific integrated circuit (ASIC), a field programmable gate array (FPGA), and/or any other hardware device suitable for retrieval and/or execution of instructions from the machine-readable medium 520 (e.g., instructions 521-525) to perform functions related to various examples. Additionally, or alternatively, the processor 510 may include electronic circuitry for performing the functionality described herein, including the functionality of instructions 521-525. With respect of the executable instructions represented as boxes in FIG. 5, it should be understood that part or all of the executable instructions and/or electronic circuits included within one box may, in alternative implementations, be included in a different box shown in the figures or in a different box not shown.

The machine-readable medium 520 may be any medium suitable for storing executable instructions, such as a random-access memory (RAM), electrically erasable programmable read-only memory (EEPROM), flash memory, hard disk drives, optical disks, and the like. In some example implementations, the machine-readable medium 520 may be a tangible, non-transitory medium, where the term “non-transitory” does not encompass transitory propagating signals. The machine-readable medium 520 may be disposed within the processor-based system 500, as shown in FIG. 5, in which case the executable instructions may be deemed “installed” on the system 500. Alternatively, the machine-readable medium 520 may be a portable (e.g., external) storage medium, for example, that allows system 500 to remotely execute the instructions or download the instructions from the storage medium. In this case, the executable instructions may be part of an “installation package.” As described further herein below, the machine-readable medium may be encoded with a set of executable instructions 521-525.

Instructions 521, when executed by the processor 510, may cause the processor 510 to receive a servicing operation request.

Instructions 522, when executed by the processor 510, may cause the processor 510 to determine that a cleaning accessory 140 has been successfully installed on a carriage 130 of a printing apparatus 100 to clean a transfer belt from the printing apparatus 100.

Instructions 523, when executed by the processor 510, may cause the processor 510 to control an element from a conduit assembly 150 such that the conduit extracts airborne particles from a printing zone on the transfer belt.

Instructions 524, when executed by the processor 510, may cause the processor 510 to control the carriage 130 to reciprocate along a scanning direction 135.

Instructions 525, when executed by the processor 510, may cause the processor 510 to control the transfer belt to move along a media path direction, wherein the media path direction is a direction substantially orthogonal with respect to the scanning direction.

In some examples, the machine-readable medium may further include further instructions. For example, instructions to control a sensor to detect a density of airborne particles on a part of the transfer belt; and instructions to determine that a servicing operation is to be executed based on the density of airborne particles.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor.” The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

What it is claimed is:

1. A printing apparatus comprising:
a platen having a printing zone, the platen being to hold a media moveable along a media path direction; and
a carriage above the platen reciprocatively moveable along a scanning direction, the carriage including:
a cleaning accessory interface couplable to a cleaning accessory, the cleaning accessory to remove contaminants from the platen upon the carriage's movement; and
a conduit connectable to a vacuum source to extract the removed contaminants from the printing zone.

2. The printing apparatus of claim 1, further comprising the cleaning accessory.

3. The printing apparatus of claim 1, wherein the platen comprises a conveyor belt or a transfer belt.

4. The printing apparatus of claim 1, further comprising a controller to:
receive a servicing operation request input;
controlling a conduit element such that the conduit extracts airborne particles from the printing zone;
control the carriage to reciprocatively move along the scanning direction; and
control the transfer belt to move along the media path direction.

5. The printing apparatus of claim 4, further comprising:
a sensor mounted at the carriage to detect airborne particles on a part of the platen; and
the controller to:
control the sensor to detect the density of airborne particles on a part of the platen; and
determine that a servicing operation is to be executed based on the density of airborne particles.

6. The printing apparatus of claim 1, wherein the accessory comprises bristles.

7. The printing apparatus of claim 1, wherein the conduit is an aerosol extractor.

8. The printing apparatus of claim 1, further comprising an additional conduit, each conduit located at an opposite side of the carriage with respect to the scanning direction.

9. The printing apparatus of claim 1, wherein a nozzle of the conduit is located at a distance of 5 mm or less from the platen.

10. A method to remove contaminants from a platen of a printing apparatus, the method comprising:
installing a cleaning accessory on a carriage of the printing apparatus to clean the platen;
reciprocatively moving the carriage along a scanning direction; and
vacuuming airborne particles on the platen through a conduit coupled to a vacuum source, wherein the conduit is part of the carriage.

11. The method of claim 10, wherein the platen is a transfer belt, the method further comprising moving the transfer belt along a media path direction as the carriage is being reciprocatively moved along the scanning direction.

12. The method of claim 10, further comprising:
detecting, by a sensor, a density of airborne particles on a part of the platen;
determine that a servicing operation is to be executed based on the density of airborne particles.

13. The method of claim 10, further comprising wetting a cleaning portion of the cleaning accessory with a solvent.

14. A non-transitory machine-readable medium storing instructions executable by a processor, the non-transitory machine-readable medium comprising:
instructions to receive a servicing operation request;
instructions to determine that a cleaning accessory has been successfully installed on a carriage of a printing apparatus to clean a transfer belt from the printing apparatus;
instructions to control an element from a conduit assembly such that the conduit extracts airborne particles from a printing zone on the transfer belt;
instructions to control the carriage to reciprocatively move along a scanning direction; and
instructions to control the transfer belt to move along a media path direction, wherein the media path direction is a direction substantially orthogonal with respect to scanning direction.

15. The machine-readable medium of claim 14, further comprising:
instructions to control a sensor to detect a density of airborne particles on a part of the transfer belt; and
instructions to determine that a servicing operation is to be executed based on the density of airborne particles.
